(19) United States
(12) Patent Application Publication
(10) Pub. No.: US 2015/0175865 A1
(43) Pub. Date: Jun. 25, 2015

(54) DEHAZING AGENT

(71) Applicant: National Taiwan University, Taipei City (TW)

(72) Inventors: Bor-Shiunn Lee, Taipei City (TW); Chia-Wen Wu, Taipei City (TW)

(73) Assignee: National Taiwan University, Taipei City (TW)

(21) Appl. No.: 14/220,494

(22) Filed: Mar. 20, 2014

(30) Foreign Application Priority Data
Dec. 20, 2013 (TW) 102147548

(51) Int. Cl. C09K 3/18; C09D 183/04

(52) U.S. Cl. CPC C09K 3/18; C09D 183/04

(57) ABSTRACT

A dehazing agent includes a polyethylene glycol compound of 6˜27 wt %, a modified organic polysiloxane mixture of 45˜60 wt % and alcohol. The surface of the article being sprayed or coated with the dehazing agent becomes hydrophilic such that the contact angle of a drop of water on the article is less than 10 degrees. As a result, it lasts for 30 minutes more without forming haze on the surface of the article. The article is thus applicable to humid and warm environments so as to assist the use to work for a long time in such a circumstance.

### CROSS-REFERENCE TO RELATED APPLICATION

This application claims the priority of Taiwanese patent application No. 102147548, filed on Dec. 20, 2013, which is incorporated herewith by reference.

### BACKGROUND OF THE INVENTION

1. Field of the Invention

The present invention generally relates to a dehazing agent, and more specifically to a dehazing agent applicable to humid, warm environments for greatly increasing the time to form the haze and improving the effect of dehazing.

2. The Prior Arts

Generally, the swimming goggles and the stomatoscope in the dental treatment are used in humid and warm environments because of human body temperature. In particular, the dentist usually needs to spray a lot of water during the dental therapy, and it is easy to form water haze, which blurs the dental's sight and causes some inconvenience for the treatment. The problem of hazing can be solved by spraying water onto the swimming goggles or the stomatoscope, or immersing the swimming goggles or the stomatoscope in hot water, soap water or alcohol. However, the effective period of time is only about 5 minutes. For expert swimmers to swim a long distance or dentists to perform the dental treatment or work on fine inspection for a long time, it is possible to have to stop the ongoing action or change the posture, leading to great inconvenience.

Some commercial dehazing agents with specific ingredients are available; however, the dehazing effect in the humid and warm environments is almost similar to what happens to hot water, soap water or alcohol. Examined by the contact angle instrument, the contact angle of the water drop on the swimmer goggles or the stomatoscope without coating hot water, soap water or alcohol is about 50-65 degrees. The form of water drop and the hydrophobic property are the primary reasons to form water haze. Additionally, the water drop may even cause reflection, and the use's sight is further seriously affected. The contact angle can be reduced to 20 degrees around after coating the commercial dehazing agent, but it only last for a short period of time.

The commercial dehazing agent is not popular due to high cost and limited effect, and it thus greatly needs a new dehazing agent, which is low in cost, has the hydrophilic property, and provides a long term of dehazing effect working well in high humid and warm environments, thereby solving the issues in the prior arts.

### SUMMARY OF THE INVENTION

A primary objective of the present invention is to provide a dehazing agent, which includes a polyethylene glycol compound with 6˜27 wt %, a modified organic polysiloxane mixture of 45˜60 wt % and alcohol. Specifically, the modified organic polysiloxane mixture is specified by a chemical structure formula:

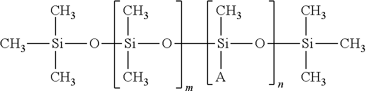

and A is selected from a group consisting of at least one of an ether group, a long alkyl group, a phenyl group, a phenyl alkyl group, a high aliphatic ester and a high aliphatic ester amide group.

Once the surface of an article (or product) is coated or sprayed by the dehazing agent of the present invention, the article becomes hydrophilic such that a drop of water on the article immediately spreads and the contact angle is less than 10 degrees. Further, the dehazing agent causes the article to last for 30 minutes more without forming haze and therefore, the resulting article is applicable to humid and warm environments so as to greatly assist the use and improve the convenience in actual usage.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing the contact angle for the comparative example by use of the contact angle instrument; and

FIGS. 2 to 8 are views respectively showing the contact angle for the experimental examples 1-7 according to the present invention by use of the contact angle instrument.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

The present invention generally relates to a dehazing agent, which includes a polyethylene glycol compound with 6˜27 wt %, a modified organic polysiloxane mixture of 45˜60 wt % and alcohol. Specifically, the polyethylene glycol compound includes at least poly(ethylene glycol)-poly(propylene glycol)-poly(ethylene glycol), that is PEG-PEG-PEG or P-123. The modified organic polysiloxane mixture is specified by a chemical structure formula:

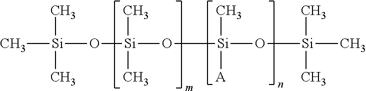

where A is selected from a group consisting of at least one of an ether group, a long alkyl group, a phenyl group, a phenyl alkyl group, a high aliphatic ester and a high aliphatic ester amide group. For example, one of available commercial products is K-351 series produced by Shin-Etsu Chemical Co., Ltd. in Japan.

One of the key features is that the dehazing agent of the present invention keeps stable contact on the mirror surface. As a result, after the dehazing agent of the present invention is coated or sprayed on the surface of the article, like glass, a drop of water on the surface will spread immediately, and the contact angle is less than 10 degrees. More specifically, the dehazing agent can sustain the effect of dehazing for at least 30 minutes.

The following comparative and experimental examples according to the present invention are intended to illustrate the respective values of the contact angle, which are the average values of three data measured by the contact angle instrument.

### COMPARATIVE EXAMPLE

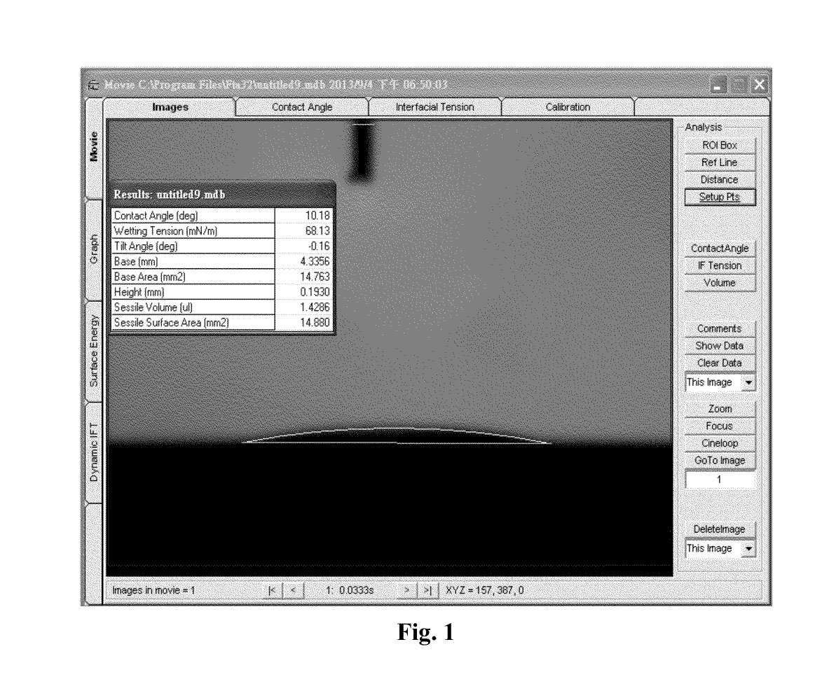

As a comparative example, a commercial dehazing product, Butler® Clear Dip, is coated or sprayed on the surface of the stomatoscope, and the contact angle of water drops is 11.39 degrees, which is shown by a photo taken by the contact angle instrument in FIG. 1. The actual effect of dehazing lasts for 7-8 minutes.

### Experimental Example 1

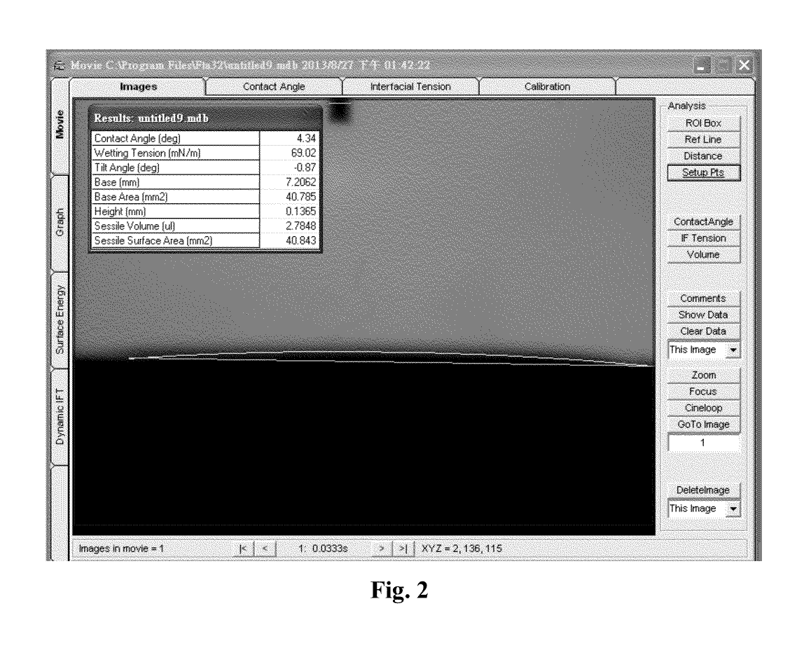

The dehazing agent of this example includes 10 wt % of P-123, 52 wt % of KF-351A, and 38 wt % of alcohol. After the dehazing agent is coated or sprayed on the surface of the stomatoscope, the contact angle of water drops is 4.59 degrees as shown in FIG. 2, which is a photo taken by the contact angle instrument. The effect of dehazing lasts for 30 minutes more.

### Experimental Example 2

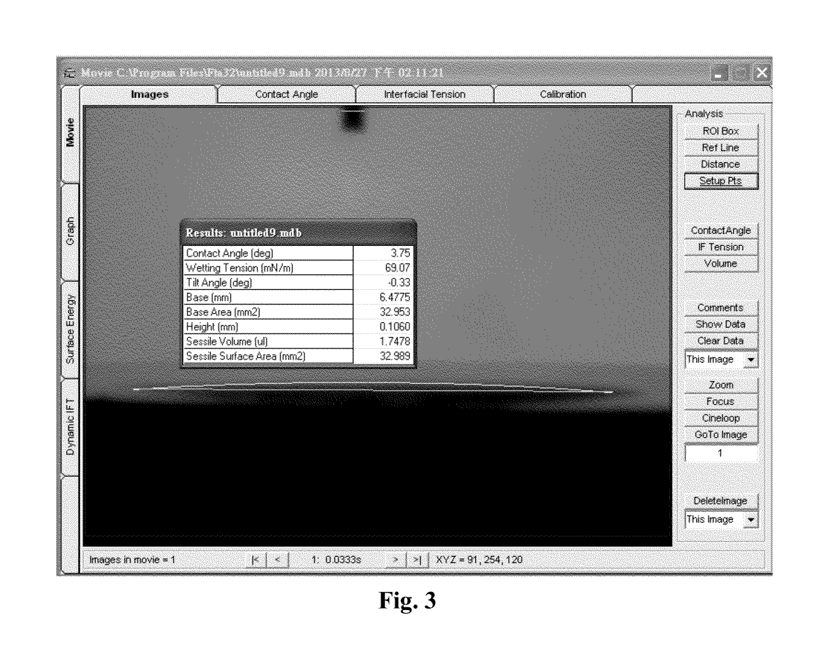

In this example, 14 wt % of P-123, 50 wt % of KF-351A, and 36 wt % of alcohol are contained in the dehazing agent, which is coated or sprayed on the surface of the stomatoscope. The contact angle of water drops is 3.83 degrees as shown in FIG. 3, which is a photo taken by the contact angle instrument, and the effect of dehazing lasts for 30 minutes more.

### Experimental Example 3

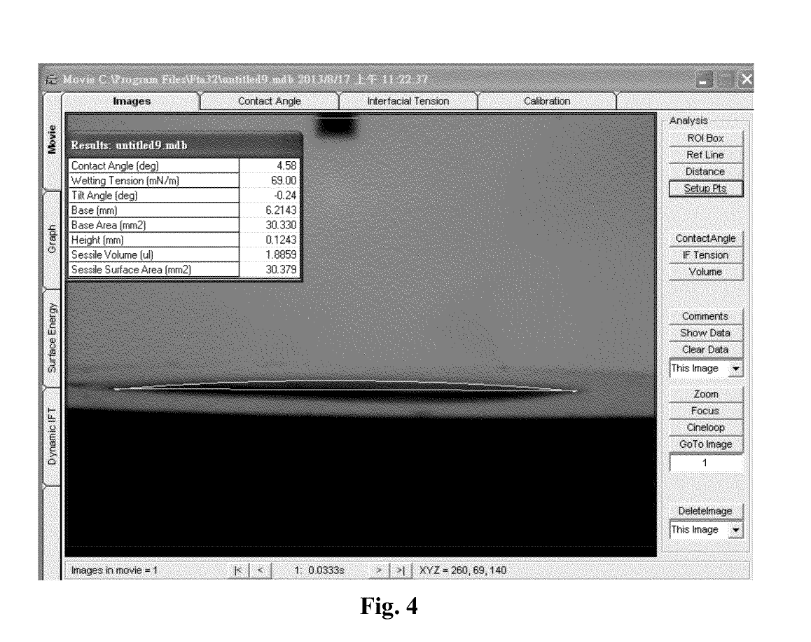

Generally, the dehazing agent is prepared with 18 wt % of P-123, 47 wt % of KF-351A, and 35 wt % of alcohol. The contact angle of water drops for the dehazing agent coated or sprayed on the surface of the stomatoscope is 4.26 degrees as shown in FIG. 4, a photo taken by the contact angle instrument. The effect of dehazing lasts for 30 minutes more.

### Experimental Example 4

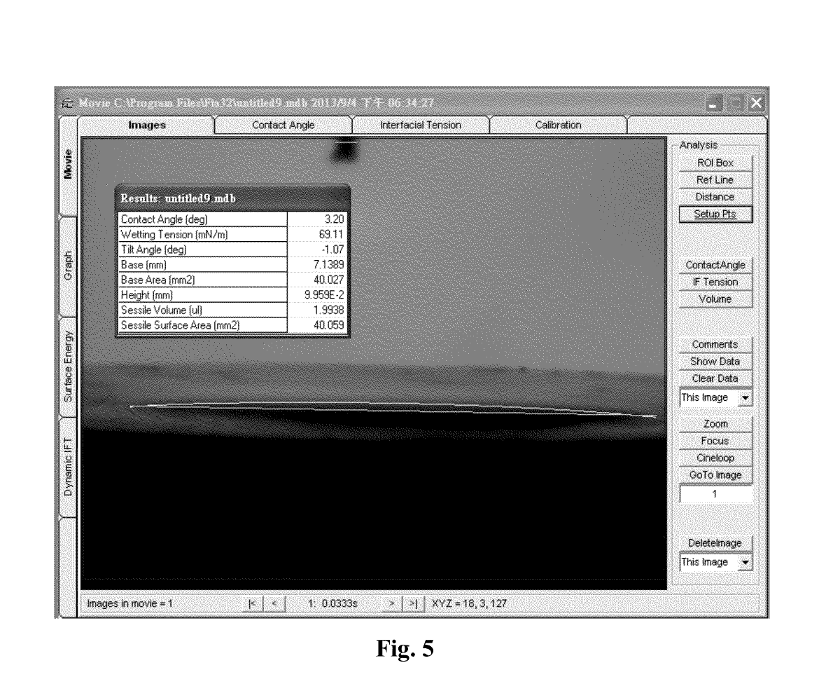

The dehazing agent of the present experimental example includes 22 wt % of P-123, 45 wt % of KF-351A, and 33 wt % of alcohol, is coated or sprayed on the surface of the stomatoscope, and the contact angle of water drops is 3.6 degrees as shown in FIG. 5, which is a photo taken by the contact angle instrument . The effect of dehazing lasts for 30 minutes more.

### Experimental Example 5

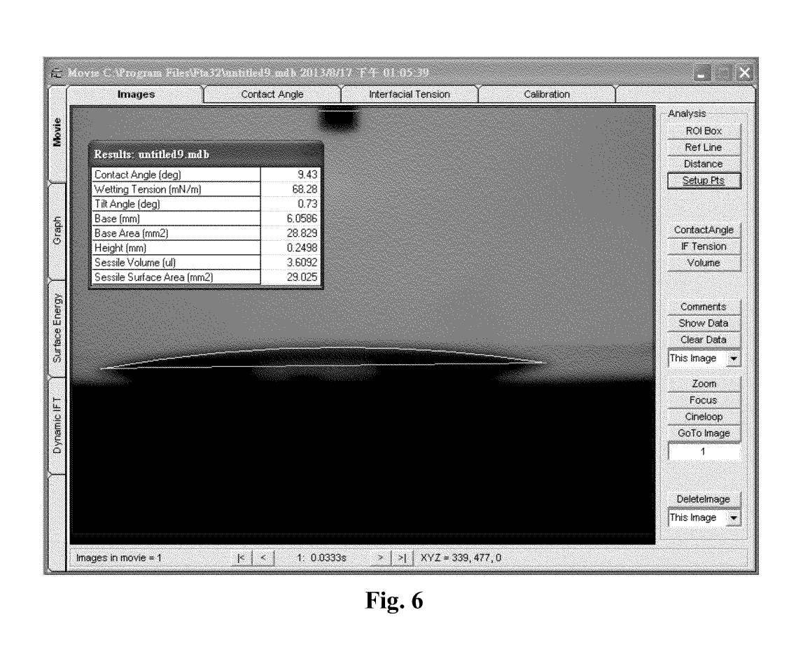

In this example, 25 wt % of P-123, 43 wt % of KF-351A, and 32 wt % of alcohol are thoroughly mixed to form the dehazing agent. After the dehazing agent is coated or sprayed on the surface of the stomatoscope, the contact angle of water drops is 8.73 degrees as shown in FIG. 6 taken by the contact angle instrument, and the effect of dehazing lasts for 30 minutes more.

### Experimental Example 6

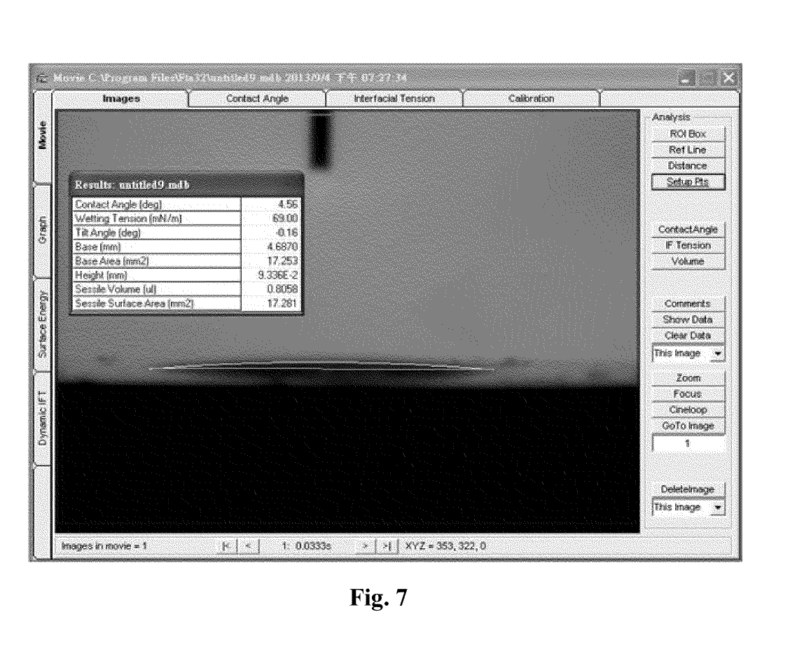

The dehazing agent includes 9 wt % of P-123, 57 wt % of KF-351A, and 34 wt % of alcohol, and is coated or sprayed on the surface of the stomatoscope. After examined by the contact angle instrument, as shown in FIG. 7, the contact angle of water drops is 4.99 degrees. The effect of dehazing lasts for 30 minutes more.

### Experimental Example 7

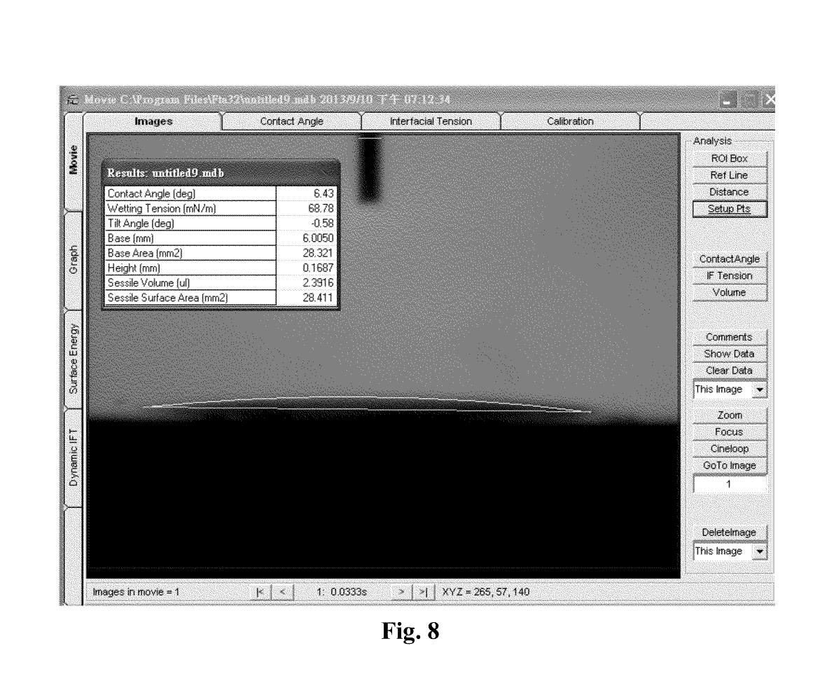

The dehazing agent of the example is prepared by mixing 20 wt % of P-123, 50 wt % of KF-351A, and 30 wt % of alcohol. After the dehazing agent is coated or sprayed on the surface of the stomatoscope, the contact angle of water drops is 6.50 degrees as shown in FIG. 8, which is a photo taken by the contact angle instrument. The effect of dehazing lasts for 30 minutes more.

From the above examples, it is obvious that the dehazing agent of the present invention on the stomatoscope can cause the surface of the stomatoscope to be hydrophilic such that a water film is easily formed and the contact angle of the water drop is less than 10 degrees. Especially, the effect of dehazing can last for more than 30 minutes. As a result, it is hard to form the haze on the surface of the stomatoscope. Specifically, the stomatoscope can works well in the humid and warm environments without causing the haze so as to assist the user or the dentist to perform some medical treatment for mouth or teeth.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A dehazing agent for spraying or coating on a surface of an article, comprising:
a polyethylene glycol compound with 6˜27 wt %;
a modified organic polysiloxane mixture of 45˜60 wt %; and
alcohol,
wherein the modified organic polysiloxane mixture is specified by a chemical structure formula: 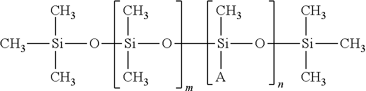
where A is selected from a group consisting of at least one of an ether group, a long alkyl group, a phenyl group, a phenyl alkyl group, a high aliphatic ester and a high aliphatic ester amide group.

2. The dehazing agent as claimed in claim 1, wherein the polyethylene glycol compound includes at least poly(ethylene glycol)-poly(propylene glycol)-poly(ethylene glycol), or P-123.

3. The dehazing agent as claimed in claim 1, wherein the surface of the article has a contact angle corresponding to a drop of water less than 10 degrees after being sprayed or coated by the dehazing agent.
